(19) United States
(12) Patent Application Publication
(10) Pub. No.: US 2022/0343251 A1
(43) Pub. Date: Oct. 27, 2022

(54) METHOD AND SYSTEM FOR TASK ASSIGNMENT AND ALLOCATION

(71) Applicant: JPMorgan Chase Bank, N.A., New York, NY (US)

(72) Inventors: Brandon Chihkai YANG, Chicago, IL (US); Philip JACOB, Chicago, IL (US); Maredia Ramiz KARIM, Allen, TX (US); Maria G. RECINE, Glen Head, NY (US); Sohajpal SHERGILL, Aurora, IL (US); Shruti JAIN, Addison, TX (US); Ravi HELA, Kolkata (IN); Frank IX, Chicago, IL (US); Abhishek MITRA, Bangalore (IN); Maria BELTRAN, Chicago, IL (US)

(73) Assignee: JPMorgan Chase Bank, N.A., New York, NY (US)

(21) Appl. No.: 17/660,153

(22) Filed: Apr. 21, 2022

Related U.S. Application Data
(60) Provisional application No. 63/197,030, filed on Jun. 4, 2021.

(30) Foreign Application Priority Data
Apr. 22, 2021 (IN) 202111018580

(51) Int. Cl. G06Q 10/06

(52) U.S. Cl. CPC G06Q 10/06316; G06Q 10/063114; G06Q 10/063112; G06Q 10/06398

(57) ABSTRACT

A method and a system for automating a task assignment and allocation process using an algorithmic approach that is designed for optimizing resource experience and availability in order to improve efficiency and client outcomes is provided. The method includes receiving task-related information; receiving candidate attribute information; receiving historical interaction information with respect to the client; analyzing the received information; and determining, based on a result of the analysis, a primary task assignment that includes an identification of at least one candidate as a primary responsible party for performing the task and a proposed schedule for completing the task. The analysis may be performed by applying an algorithm that uses the received information as input. The determination of the primary task assignment may be based on an output of the algorithm.

### CROSS-REFERENCE TO RELATED APPLICATIONS

This application claims priority benefit from Indian Application No. 202111018580, filed Apr. 22, 2021, which is hereby incorporated by reference in its entirety.

This application claims priority from U.S. Provisional Patent Application No. 63/197,030, filed in the U.S. Patent and Trademark Office on Jun. 4, 2021, which is hereby incorporated by reference in its entirety.

### BACKGROUND

### 1. Field of the Disclosure

This technology generally relates to methods and systems for allocating tasks in a workplace environment, and more particularly to methods and systems for automating a task assignment and allocation process using an algorithmic approach that is designed for optimizing resource experience and availability in order to improve efficiency and client outcomes.

### 2. Background Information

In a large financial institution such as a bank, although a client journey may begin with a telephone call or a meeting, long-term success is dependent on what happens after negotiations are complete and agreements are signed. In particular, a true measure of success rests in how client needs are handled after a sale is made and downstream implementation and service professionals commence work.

In a typical month, partly as a function of the size of the bank, a client onboarding team may execute a large number of product implementations across multiple geographic, service, and product level complexities. Aligning suitable personnel to appropriate tasks in a timely manner is critical to providing an optimal client experience. However, allocating and assigning tasks to personnel in a conventional manner is a time-intensive manual process. Conventionally, this process has relied upon labor-intensive qualitative analyses of teamwide capacity and workload metrics.

Accordingly, there is a need for a mechanism for automating a task assignment and allocation process using an algorithmic approach that is designed for optimizing resource experience and availability in order to improve efficiency and client outcomes.

### SUMMARY

The present disclosure, through one or more of its various aspects, embodiments, and/or specific features or sub-components, provides, inter alia, various systems, servers, devices, methods, media, programs, and platforms for automating a task assignment and allocation process using an algorithmic approach that is designed for optimizing resource experience and availability in order to improve efficiency and client outcomes.

According to an aspect of the present disclosure, a method for assigning a task to be performed for a client is provided. The method is implemented by at least one processor. The method includes: receiving, by the at least one processor, first information that relates to the task; receiving, by the at least one processor, second information that relates to personnel-specific attributes of a plurality of candidates for performing the task; receiving, by the at least one processor, third information that relates to at least one historical interaction between the client and at least one from among the plurality of candidates; analyzing, by the at least one processor, each of the first information, the second information, and the third information; and determining, by the at least one processor based on a result of the analyzing, a primary task assignment that includes an identification of at least one person from among the plurality of candidates as a primary responsible party for performing the task and a proposed schedule for completing the performing of the task.

The analyzing may include applying an algorithm for which each of at least a subset of the first information, at least a subset of the second information, and at least a subset of the third information is an input. The determining may include determining the primary task assignment based on an output of the algorithm.

The method may further include displaying a user interface on a computer screen. Each of the first information, the second information, and the third information may be received via the user interface.

The first information may include at least one from among a schedule requirement, a skill requirement, and a task complexity.

The second information may include at least one from among past competitor work experience, historical work performed for the client, historical work performed for an affiliate of the client, historical work performed in relation to an industry of the client, and historical work performed with respect to a product that relates to the task.

The third information may include at least one from among information relating to a separate task that is currently being performed for the client, a client satisfaction score that relates to at least one previously performed task, and a time for completion of a previously performed task with respect to a product that relates to the task.

The method may further include determining a secondary task assignment that includes an identification of at least one person from among the plurality of candidates as an alternative responsible party for performing the task, wherein the alternative responsible party is different from the primary responsible party.

The method may further include receiving fourth information that relates to at least one managerial preference. The analyzing may include analyzing the fourth information, and the result of the analyzing may change due to the fourth information.

The fourth information may include at least one from among an emphasis that relates to a respective availability of each of the plurality of candidates, an emphasis that relates to a recency of past competitor work experience, and an emphasis that relates to employment tenure of each of the plurality of candidates.

According to another aspect of the present disclosure, a computing apparatus for assigning a task to be performed for a client is provided. The computing apparatus includes a processor; a memory; a display; and a communication interface coupled to each of the processor, the memory, and the display. The processor is configured to: receive, via the communication interface, first information that relates to the task; receive, via the communication interface, second information that relates to personnel-specific attributes of a plurality of candidates for performing the task; receive, via the communication interface, third information that relates to at least one historical interaction between the client and at least one from among the plurality of candidates; analyze each of the first information, the second information, and the third information; and determine, by the at least one processor based on a result of the analysis, a primary task assignment that includes an identification of at least one person from among the plurality of candidates as a primary responsible party for performing the task and a proposed schedule for completing the performing of the task.

The processor may be further configured to perform the analysis by applying an algorithm for which each of at least a subset of the first information, at least a subset of the second information, and at least a subset of the third information is an input, and to determine the primary task assignment based on an output of the algorithm.

The processor may be further configured to cause the display to display a user interface. Each of the first information, the second information, and the third information may be received via the user interface.

The first information may include at least one from among a schedule requirement, a skill requirement, and a task complexity.

The second information may include at least one from among past competitor work experience, historical work performed for the client, historical work performed for an affiliate of the client, historical work performed in relation to an industry of the client, and historical work performed with respect to a product that relates to the task.

The third information may include at least one from among information relating to a separate task that is currently being performed for the client, a client satisfaction score that relates to at least one previously performed task, and a cycle time for completion of a previously performed task with respect to a product that relates to the task.

The processor may be further configured to determine a secondary task assignment that includes an identification of at least one person from among the plurality of candidates as an alternative responsible party for performing the task, wherein the alternative responsible party is different from the primary responsible party.

The processor may be further configured to receive, via the communication interface, fourth information that relates to at least one managerial preference, and to analyze the fourth information. The result of the analysis may change due to the fourth information.

The fourth information may include at least one from among an emphasis that relates to a respective availability of each of the plurality of candidates, an emphasis that relates to a recency of past competitor work experience, and an emphasis that relates to employment tenure of each of the plurality of candidates.

According to yet another aspect of the present disclosure, a non-transitory computer readable storage medium storing instructions for assigning a task to be performed for a client is provided. The storage medium includes executable code which, when executed by a processor, causes the processor to: receive first information that relates to the task; receive second information that relates to personnel-specific attributes of a plurality of candidates for performing the task; receive third information that relates to at least one historical interaction between the client and at least one from among the plurality of candidates; analyze each of the first information, the second information, and the third information; and determine, based on a result of the analysis, a primary task assignment that includes an identification of at least one person from among the plurality of candidates as a primary responsible party for performing the task and a proposed schedule for completing the performing of the task.

The executable code may further cause the processor to apply an algorithm for which each of at least a subset of the first information, at least a subset of the second information, and at least a subset of the third information is an input, and to determine the primary task assignment based on an output of the algorithm.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for automating a task assignment and allocation process using an algorithmic approach that is designed for optimizing resource experience and availability in order to improve efficiency and client outcomes.

FIG. 4 is a flowchart of an implementation of a method for automating a task assignment and allocation process using an algorithmic approach that is designed for optimizing resource experience and availability in order to improve efficiency and client outcomes.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

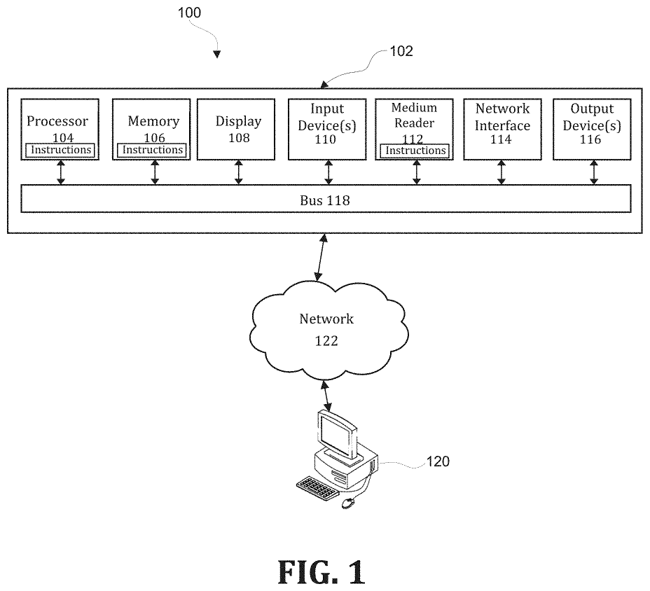

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automating a task assignment and allocation process using an algorithmic approach that is designed for optimizing resource experience and availability in order to improve efficiency and client outcomes.

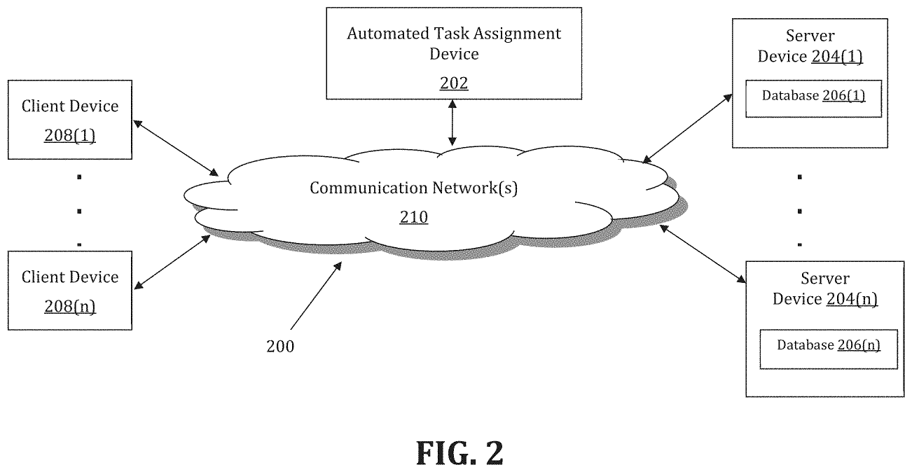

Referring to FIG. 2, a schematic of an exemplary network environment 200 for implementing a method for automating a task assignment and allocation process using an algorithmic approach that is designed for optimizing resource experience and availability in order to improve efficiency and client outcomes is illustrated. In an exemplary embodiment, the method is executable on any networked computer platform, such as, for example, a personal computer (PC).

The method for automating a task assignment and allocation process using an algorithmic approach that is designed for optimizing resource experience and availability in order to improve efficiency and client outcomes may be implemented by an Automated Task Assignment (ATA) device 202. The ATA device 202 may be the same or similar to the computer system 102 as described with respect to FIG. 1. The ATA device 202 may store one or more applications that can include executable instructions that, when executed by the ATA device 202, cause the ATA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ATA device 202 itself, may be located in virtual server(s) running in a cloud-based computing environment rather than being tied to one or more specific physical network computing devices. Also, the application(s) may be running in one or more virtual machines (VMs) executing on the ATA device 202. Additionally, in one or more embodiments of this technology, virtual machine(s) running on the ATA device 202 may be managed or supervised by a hypervisor.

In the network environment 200 of FIG. 2, the ATA device 202 is coupled to a plurality of server devices 204(1)-204(n) that hosts a plurality of databases 206(1)-206(n), and also to a plurality of client devices 208(1)-208(n) via communication network(s) 210. A communication interface of the ATA device 202, such as the network interface 114 of the computer system 102 of FIG. 1, operatively couples and communicates between the ATA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ATA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ATA devices that efficiently implement a method for automating a task assignment and allocation process using an algorithmic approach that is designed for optimizing resource experience and availability in order to improve efficiency and client outcomes.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ATA device 202 may be a standalone device or integrated with one or more other devices or apparatuses, such as one or more of the server devices 204(1)-204(n), for example. In one particular example, the ATA device 202 may include or be hosted by one of the server devices 204(1)-204(n), and other arrangements are also possible. Moreover, one or more of the devices of the ATA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ATA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to personnel capabilities and knowledge and data that relates to team-specific attributes and availabilities.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ATA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ATA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ATA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ATA device 202, the server devices 204(1)-204(n), or the client devices 208(1)-208(n), for example, may be configured to operate as virtual instances on the same physical machine. In other words, one or more of the ATA device 202, the server devices 204(1)-204(n), or the client devices 208(1)-208(n) may operate on the same physical device rather than as separate devices communicating through communication network(s) 210. Additionally, there may be more or fewer ATA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof

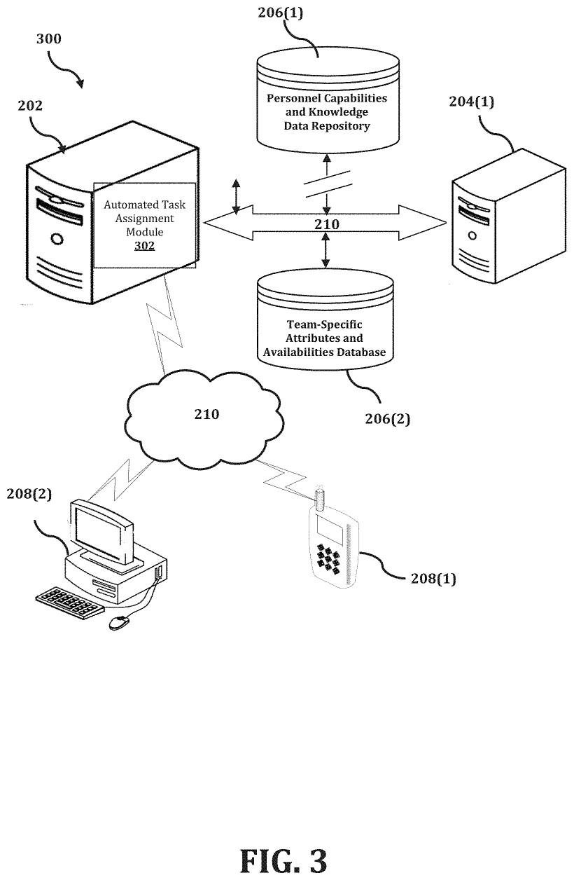

The ATA device 202 is described and illustrated in FIG. 3 as including an automated task assignment module 302, although it may include other rules, policies, modules, databases, or applications, for example. As will be described below, the automated task assignment module 302 is configured to implement a method for automating a task assignment and allocation process using an algorithmic approach that is designed for optimizing resource experience and availability in order to improve efficiency and client outcomes.

An exemplary process 300 for implementing a mechanism for automating a task assignment and allocation process using an algorithmic approach that is designed for optimizing resource experience and availability in order to improve efficiency and client outcomes by utilizing the network environment of FIG. 2 is illustrated as being executed in FIG. 3. Specifically, a first client device 208(1) and a second client device 208(2) are illustrated as being in communication with ATA device 202. In this regard, the first client device 208(1) and the second client device 208(2) may be “clients” of the ATA device 202 and are described herein as such. Nevertheless, it is to be known and understood that the first client device 208(1) and/or the second client device 208(2) need not necessarily be “clients” of the ATA device 202, or any entity described in association therewith herein. Any additional or alternative relationship may exist between either or both of the first client device 208(1) and the second client device 208(2) and the ATA device 202, or no relationship may exist.

Further, ATA device 202 is illustrated as being able to access a personnel capabilities and knowledge data repository 206(1) and a team-specific attributes and availabilities database 206(2). The automated task assignment module 302 may be configured to access these databases for implementing a method for automating a task assignment and allocation process using an algorithmic approach that is designed for optimizing resource experience and availability in order to improve efficiency and client outcomes.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ATA device 202 via broadband or cellular communication. Of course, these embodiments are merely exemplary and are not limiting or exhaustive.

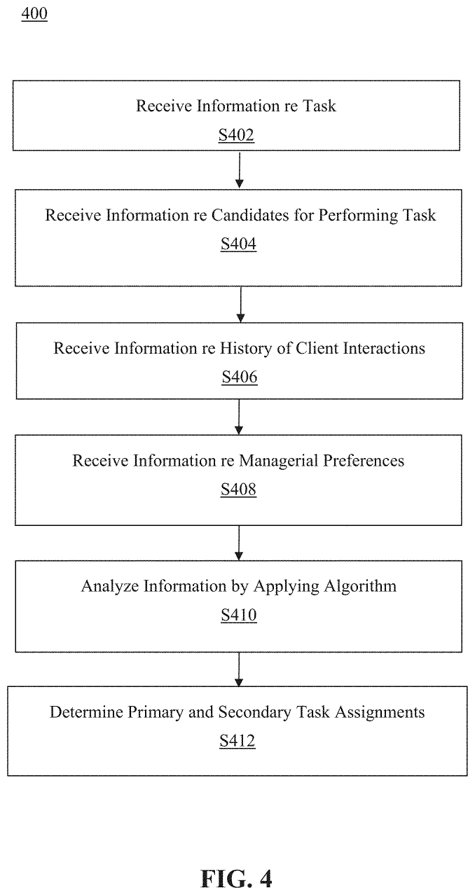

Upon being started, the automated task assignment module 302 executes a process for automating a task assignment and allocation process using an algorithmic approach that is designed for optimizing resource experience and availability in order to improve efficiency and client outcomes. An exemplary process for automating a task assignment and allocation process using an algorithmic approach that is designed for optimizing resource experience and availability in order to improve efficiency and client outcomes is generally indicated at flowchart 400 in FIG. 4.

In process 400 of FIG. 4, at step S402, the automated task assignment module 302 receives first information that relates to a task to be performed for a client. In an exemplary embodiment, the first information may include any one or more of a capacity requirement, a schedule requirement, a skill requirement, and/or a task complexity. For example, the first information may indicate how much work a particular task involves. In an exemplary embodiment, the first information may be received via a user interface that is displayed on a display, i.e., a computer screen, and that includes prompts that facilitate user entry of information that relates to capacities, schedule requirements, skill requirements, task complexities, and/or any other suitable types of information that relates to such tasks.

At step S404, the automated task assignment module 302 receives second information that relates to personnel-specific attributes of candidates for performing the task. In an exemplary embodiment, the second information may include any one or more of availability of each candidate, past competitor work experience of a particular candidate, historical work performed for the client by a particular candidate, historical work performed for an affiliate of the client by a particular candidate, historical work performed in relation to an industry of the client by a particular candidate, and/or historical work performed with respect to a product that relates to the task by a particular candidate. In an exemplary embodiment, the second information may be received via the user interface.

At step S406, the automated task assignment module 302 receives third information that relates to historical interactions between the client and respective candidates. In an exemplary embodiment, the third information may include at least one from among information relating to a separate task that is currently being performed for the client, a client satisfaction score that relates to at least one previously performed task, and/or a cycle time for completion of a previously performed task with respect to a product that relates to the task. In an exemplary embodiment, the third information may be received via the user interface.

At step S408, the automated task assignment module 302 receives fourth information that relates to managerial preferences. In an exemplary embodiment, the fourth information may include any one or more of an emphasis that relates to a respective availability of each of the plurality of candidates, an emphasis that relates to a recency of past competitor work experience, and/or an emphasis that relates to employment tenure of each of the plurality of candidates. In an exemplary embodiment, the fourth information may be received via the user interface.

At step S410, the automated task assignment module 302 analyzes the received information. In an exemplary embodiment, the analysis may be performed by applying an algorithm that uses subsets of the received first information, second information, and third information as inputs, and may also use a subset of the fourth information as an additional input.

At step S412, the automated task assignment module 302 determines one or more proposed task assignments based on a result of the analysis performed in step S410. In an exemplary embodiment, the output of the algorithm may indicate proposed task assignments that include an identification of at least one person from the list of candidates as a responsible party for performing the task and a proposed schedule for completing the performing of the task. In an exemplary embodiment, the algorithm may assign numerical values to each item of input information and then use a mathematical formula to combine the numerical values to produce a score for each candidate.

For example, the output of the algorithm may include a primary task assignment that includes a primary responsible party and a proposed schedule for task completion. The primary responsible party may be a single individual person, such as an employee, a contractor, or an affiliate. Alternatively, the primary responsible party may be a group of individuals or a group that is designated by a group name, such as a department from within a commercial organization.

The output of the algorithm may further include a secondary task assignment that includes a secondary responsible party. In an exemplary embodiment, the output of the algorithm may include a ranked listing of proposed task assignments that respectively include identifications of various possible responsible parties. The ranked listing may be accompanied by numerical scores that indicate a relative ranking of each candidate for performing the task. The number of proposed task assignments may be any number that corresponds to the possible combinations of candidates.

In an exemplary embodiment, the algorithm may be executed with only the first information, the second information, and the third information as inputs, and then, if desired, the algorithm may be re-executed with the fourth information as an additional input. In this scenario, it is possible that the scores of the possible responsible parties may change due to the fourth information, and a different primary responsible party and/or a different secondary responsible party may be identified.

In an exemplary embodiment, an algorithm-powered portal that interprets, quantifies, and recommends work allocations based on a multitude of factors and conditions is provided. The algorithm is designed to use a statistical approach to identify the key attributes and/or factors of a particular assignment or task and how those attributes and factors impacted the way that work tasks had historically been allocated. By identifying the most complex attributes of a request, the algorithm is able to score and categorize each implementation.

The associated data assists with gaining a better understanding of the impact of each assignment, including effort, duration, capacity, and requests that are currently underway with the same client. As a result, a holistic view of a team's workload is generated, thus facilitating an improvement in the handling of incoming task requests and generating assignments for those requests based on resource experience and availability.

In an exemplary embodiment, the algorithm is designed to implement complexity scoring by scoring and categorizing each incoming task request based on key request attributes, and by quantifying an impact of an assignment based on effort and duration. The algorithm may also rank assignment feasibility according to an impact to a current workload associated with a particular candidate. In an exemplary embodiment, the algorithm uses attribute scores, i.e., numerical values assigned to each of a set of individual attributes, and contribution factors, i.e., weights assigned to each of the individual attributes to reflect the respective relative importance of each attribute, and then additively combines the weighted attribute scores, thereby generating an overall score for a particular task. The individual attributes may include numeric work effort drivers, such as a number of entities, a number of accounts, or a number of account openings; and qualitative work effort drivers, such as, for example, whether client early engagement is required, whether the request is a rush request, a request initiator, whether the client is a new client, a product complexity (e.g., high complexity, medium complexity, or low complexity), a product setup type, a country of account opening, whether a technical team involvement is required, whether pilot products are being used, and whether a private bank is involved.

In an exemplary embodiment, the algorithm is designed to implement employee knowledge mapping by converting employee knowledge into a list of aggregable features and mapping employee knowledge requirements for each incoming request. The algorithm may also rank assignment feasibility according to the knowledge map. For example, the employee knowledge feature may relate to any one or more of the following: past competitor work experience, i.e., whether an employee has past work experience at a competitor specified in an incoming task request; historical work for client, i.e., number of past requests worked by an employee for the client at an ultimate parent level specified in the incoming request; historical work for client sub-line of business (i.e., sub-LOB), i.e., number of past requests worked by an employee for the sub-LOB of the client at the ultimate parent level specified in the incoming request; historical work for client industry, i.e., number of past requests worked by an employee for the client's industry; historical work for client's treasury management officer (TMO), i.e., number of past request worked by an employee for the TMO of the client at the ultimate parent level specified in the incoming request; and historical work by product combination, i.e., whether an employee has past work experience on the same product combination as that specified in the incoming request.

In an exemplary embodiment, the algorithm is designed to implement client experience tallying by converting client experience into a list of aggregable features and aggregating experience factors based on relevance to a particular task request. The algorithm may also rank assignment feasibility according to the experience tally. For example, the client experience feature may relate to any one or more of the following: parallel task for client, i.e., whether an employee is currently working on any request for the same client; client satisfactions (CSAT) score by client, i.e., calculate the average CSAT score for tasks previously performed by an employee for the client; and average cycle time based on product pattern, i.e., calculate the average cycle time for completing tasks by an employee with respect to the same product combination as that specified in an incoming request.

In an exemplary embodiment, the algorithm uses attribute scores, i.e., numerical values assigned to each of a set of individual attributes, and contribution factors, i.e., weights assigned to each of the individual attributes to reflect the respective relative importance of each attribute, and then additively combines the weighted attribute scores, thereby generating an overall score for a particular task.

In an exemplary embodiment, the algorithm provides flexibility for managers to optimize recommendations based on their preferences. The algorithm is designed to compile a definition of an “ideal state” for each type of incoming request by collecting historical information and using a machine learning technique. Subsequent recommendations may be benchmarked against such an ideal state to highlight constraints. The algorithm may recognize that a manager's best candidate is not recommended due to overcapacity, and in this aspect, a manager may update proximity settings by decreasing an emphasis on capacity. A temporal factor may account for a managerial preference to emphasize recent knowledge by which more recent work experience with a competitor is more highly valued. A volumetric factor may account for a managerial preference to emphasize employee tenure with the company.

A successful fulfillment measurement may account for a suite of metrics that are used to measure the success of a request fulfillment, which may in turn provide a measure of success of an assignment recommendation. Such measurements may be applied with machine learning to further optimize the assignment recommendation algorithm. In a what-if scenario analysis, simulations using various alternate situations are performed, and an assignment recommendation is made based on outcomes of the simulations. The algorithm is designed to identify a scenario that maximizes a probability of successful fulfillment across a team. In a bidirectional optimization, assignment recommendations are optimized between a complexity score and an overall algorithmic score based on the ideal state.

Accordingly, with this technology, an optimized process for automating a task assignment and allocation process using an algorithmic approach that is designed for optimizing resource experience and availability in order to improve efficiency and client outcomes is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for assigning a task to be performed for a client, the method being implemented by at least one processor, the method comprising:
receiving, by the at least one processor, first information that relates to the task;
receiving, by the at least one processor, second information that relates to personnel-specific attributes of a plurality of candidates for performing the task;
receiving, by the at least one processor, third information that relates to at least one historical interaction between the client and at least one from among the plurality of candidates;
analyzing, by the at least one processor, each of the first information, the second information, and the third information; and
determining, by the at least one processor based on a result of the analyzing, a primary task assignment that includes an identification of at least one person from among the plurality of candidates as a primary responsible party for performing the task and a proposed schedule for completing the performing of the task.

2. The method of claim 1, wherein the analyzing comprises applying an algorithm for which each of at least a subset of the first information, at least a subset of the second information, and at least a subset of the third information is an input, and wherein the determining comprises determining the primary task assignment based on an output of the algorithm.

3. The method of claim 1, further comprising displaying, on a computer screen, a user interface,
wherein each of the first information, the second information, and the third information is received via the user interface.

4. The method of claim 1, wherein the first information includes at least one from among a schedule requirement, a skill requirement, and a task complexity.

5. The method of claim 1, wherein the second information includes at least one from among past competitor work experience, historical work performed for the client, historical work performed for an affiliate of the client, historical work performed in relation to an industry of the client, and historical work performed with respect to a product that relates to the task.

6. The method of claim 1, wherein the third information includes at least one from among information relating to a separate task that is currently being performed for the client, a client satisfaction score that relates to at least one previously performed task, and a time for completion of a previously performed task with respect to a product that relates to the task.

7. The method of claim 1, further comprising determining a secondary task assignment that includes an identification of at least one person from among the plurality of candidates as an alternative responsible party for performing the task, wherein the alternative responsible party is different from the primary responsible party.

8. The method of claim 1, further comprising receiving fourth information that relates to at least one managerial preference,
wherein the analyzing comprises analyzing the fourth information, and the result of the analyzing changes due to the fourth information.

9. The method of claim 8, wherein the fourth information includes at least one from among an emphasis that relates to a respective availability of each of the plurality of candidates, an emphasis that relates to a recency of past competitor work experience, and an emphasis that relates to employment tenure of each of the plurality of candidates.

10. A computing apparatus for assigning a task to be performed for a client, the computing apparatus comprising:
a processor;
a memory;
a display; and
a communication interface coupled to each of the processor, the memory, and the display,
wherein the processor is configured to:
receive, via the communication interface, first information that relates to the task;
receive, via the communication interface, second information that relates to personnel-specific attributes of a plurality of candidates for performing the task;
receive, via the communication interface, third information that relates to at least one historical interaction between the client and at least one from among the plurality of candidates;
analyze each of the first information, the second information, and the third information; and
determine, by the at least one processor based on a result of the analysis, a primary task assignment that includes an identification of at least one person from among the plurality of candidates as a primary responsible party for performing the task and a proposed schedule for completing the performing of the task.

11. The computing apparatus of claim 10, wherein the processor is further configured to perform the analysis by applying an algorithm for which each of at least a subset of the first information, at least a subset of the second information, and at least a subset of the third information is an input, and to determine the primary task assignment based on an output of the algorithm.

12. The computing apparatus of claim 10, wherein the processor is further configured to cause the display to display a user interface, and
wherein each of the first information, the second information, and the third information is received via the user interface.

13. The computing apparatus of claim 10, wherein the first information includes at least one from among a schedule requirement, a skill requirement, and a task complexity.

14. The computing apparatus of claim 10, wherein the second information includes at least one from among past competitor work experience, historical work performed for the client, historical work performed for an affiliate of the client, historical work performed in relation to an industry of the client, and historical work performed with respect to a product that relates to the task.

15. The computing apparatus of claim 10, wherein the third information includes at least one from among information relating to a separate task that is currently being performed for the client, a client satisfaction score that relates to at least one previously performed task, and a time for completion of a previously performed task with respect to a product that relates to the task.

16. The computing apparatus of claim 10, wherein the processor is further configured to determine a secondary task assignment that includes an identification of at least one person from among the plurality of candidates as an alternative responsible party for performing the task, wherein the alternative responsible party is different from the primary responsible party.

17. The computing apparatus of claim 10, wherein the processor is further configured to receive, via the communication interface, fourth information that relates to at least one managerial preference, and to analyze the fourth information, and
wherein the result of the analysis changes due to the fourth information.

18. The computing apparatus of claim 17, wherein the fourth information includes at least one from among an emphasis that relates to a respective availability of each of the plurality of candidates, an emphasis that relates to a recency of past competitor work experience, and an emphasis that relates to employment tenure of each of the plurality of candidates.

19. A non-transitory computer readable storage medium storing instructions for assigning a task to be performed for a client, the storage medium comprising executable code which, when executed by a processor, causes the processor to:
receive first information that relates to the task;
receive second information that relates to personnel-specific attributes of a plurality of candidates for performing the task;
receive third information that relates to at least one historical interaction between the client and at least one from among the plurality of candidates;
analyze each of the first information, the second information, and the third information; and
determine, based on a result of the analysis, a primary task assignment that includes an identification of at least one person from among the plurality of candidates as a primary responsible party for performing the task and a proposed schedule for completing the performing of the task.

20. The storage medium of claim 19, wherein the executable code further causes the processor to apply an algorithm for which each of at least a subset of the first information, at least a subset of the second information, and at least a subset of the third information is an input, and to determine the primary task assignment based on an output of the algorithm.
